(19) United States
(12) Patent Application Publication
(10) Pub. No.: US 2007/0154592 A1
(43) Pub. Date: Jul. 5, 2007

(54) Sugar-free confectionery comprising xylitol or erythritol with no cooling effect

(76) Inventors: Bruno Dauchy, Lestrem (FR); Francois Delbaere, Shanghai (CN); Elsa Muller, Gonnehem (FR); Jing Yvette Zhou, Shanghai (CN)

Correspondence Address: YOUNG & THOMPSON, 745 SOUTH 23RD STREET, 2ND FLOOR, ARLINGTON, VA, 22202, US

(21) Appl. No.: 11/637,915

(22) Filed: Dec. 13, 2006

(30) Foreign Application Priority Data
Dec. 14, 2005 (FR) 0512683

(51) Int. Cl. A23G 4/00

(52) U.S. Cl. 426/3

(57) ABSTRACT

The subject of the present invention is a sugar-free confectionery rich in xylitol or erythritol, characterized in that it comprises a mixture of xylitol or erythritol and dextrins so as to reduce the cooling effect of the confectionery.

The subject of the invention is a sugar-free confectionery, with a high xylitol or erythritol content, characterized in that it has a reduced cooling effect.

The cooling effect or sensation of cooling in the mouth is linked to the negative heat of dissolution of some polyols in water, and is also linked to their rate of dissolution. Xylitol is in this respect particularly effective since it confers the most intense cooling sensation, sorbitol and erythritol have slightly lower cooling effects than xylitol, while other polyols have none or scarcely any.

When it is sought to formulate a confectionery product comprising a substantial xylitol content, the presence of this cooling effect in the mouth is not always advantageous, and in particular when the confectionery is chocolate. It is sought in some particular mint chocolates, but is undesirable in more traditional chocolates such as dark chocolate, white chocolate or milk chocolate.

Xylitol chocolate has been commercially available for a long time, but this chocolate is still characterized by this cooling sensation in the mouth. To avoid this disadvantage, the only solution was to reduce the xylitol content of the chocolate to very low values, and quite often below 10% by dry weight.

Indeed, up until now, it has been impossible to eliminate the cooling effect of crystallized xylitol confectionery products, and furthermore it has been impossible to prepare confectionery products rich in xylitol of satisfactory quality in amorphous form.

Seeking to overcome this technical problem, the applicant has the merit of having found that a sugar-free confectionery product rich in xylitol and having no cooling effect could be prepared by incorporating into the said confectionery an amorphous mixture of xylitol and indigestible dextrins.

The principle is based on the fact that the crystalline form of xylitol has an endothermic energy of dissolution and therefore exerts a cooling effect, whereas the energy of dissolution of the amorphous form is not endothermic and is therefore free of cooling effect.

This should be weighted by the solubility at 37° C.: mannitol for example has a higher heat of dissolution than sorbitol but is less cooling given its low solubility.

To prepare a confectionery product comprising xylitol in amorphous form, without the quality or the stability of the said confectionery being thereby reduced, the applicant has found that it was appropriate to prepare the confectionery from a mixture of xylitol and indigestible dextrins, which has the effect of anticrystallizing the xylitol, and to increase the glass transition temperature of the mixture.

Xylitol has a very low glass transition temperature, of the order of −20° C., that is to say that for room temperatures greater than −20° C., pure xylitol cannot exist in the glass state.

The subject of the present invention is therefore a sugar-free confectionery product rich in xylitol, characterized in that it comprises an amorphous mixture of xylitol and indigestible dextrins so as to reduce the cooling effect of the said confectionery.

The expression rich in xylitol is understood to mean, according to the present invention, the fact that the confectionery comprises, by weight on a dry basis, at least 20% and preferably at least 25% of xylitol. Indeed, such seemingly low contents are particularly high and novel for a confectionery product having no cooling effect.

The xylitol/dextrin weight ratio is between 25/75 and 75/25, preferably between 30/70 and 70/30 according to the type of confectionery considered, it being possible for some types of confectionery to have more xylitol than others, such as chewy pastes in particular. Outside such ratios, either the cooling effect is not sufficiently reduced, or the texture of the confectionery products is not appropriate. Dextrins act as anti-crystallizing agent for xylitol, thereby allowing its presence in amorphous form in the confectionery.

The expression indigestible dextrins according to the present invention is understood to mean in particular the dextrins obtained by dry roasting of starch in an acidic medium, also called pyrodextrins such as, for example, those marketed by the applicant under the name NUTRIOSE®. These dextrins may be used as they are or in their hydrogenated form.

These dextrins have number-average molecular masses (Mn) which can vary from 500 to 4500 g/mol, the best results being obtained with dextrins having number-average molecular masses of the order of 1000 to 3000 g/mol. Expressed as weight-average molecular masses (Mw), the most appropriate molecular weights according to the present invention are between 2800 and 5100 g/mol, and preferably between 4000 and 5100 g/mol.

In the case of dextrins with low molecular mass, it will be advisable, in order to obtain the best results, to combine them with other dextrins of higher Mn or Mw or with polysaccharides capable of increasing the glass transition temperature, such as for example gum arabic.

According to the present invention, it is possible to prepare various xylitol confectionery products for which a cooling effect is not desired: chewy pastes, boiled sugars, caramels. These confectionery products may, according to an advantageous variant of the present invention, be incorporated in the form of inclusions into sugar-free chocolate or else coated with chocolate, so as to obtain a sugar-free chocolate confectionery product having no cooling effect, which constitutes a novel product. Indeed, confectionery products such as, for example, chewy pastes or fondants rich in xylitol are known to a person skilled in the art, but they were up until now all characterized by a high cooling effect because of the crystalline form of the xylitol which they contained.

It will also be possible to prepare confectionery products in which only a portion comprises the mixture according to the present invention, for example multi-layer confectionery products, comprising at least one amorphous boiled sugar layer, the other layers consisting of xylitol in crystalline form.

Likewise, confectionery products comprising, in addition to the xylitol/dextrin mixture, other polyols or fillers in low quantity, such as isomalt, lactitol, mannitol, erythritol, inulin, fructo-oligosaccharides, polydextrose, gum arabic, are also covered by the present invention.

According to a variant of the present invention, the confectionery products are chewy pastes comprising a mixture of xylitol and indigestible dextrins, preferably hydrogenated. These chewy pastes comprise from 30% to 50% of xylitol by weight, and from 15% to 30% of dextrins.

As regards boiled sugars or hard caramels, these may comprise from 20% to 55% of xylitol by weight, and from 15% to 75% of dextrins.

Typically, the xylitol/dextrin weight ratio may be between 30/70 and 70/30, preferably from 30/70 to 45/55 for boiled sugars, from 35/55 to 70/30 for chewy pastes. The 60/40 ratio gives a particularly satisfactory chewy paste texture. The most conclusive boiled sugars comprise the ratios 30/70 to 45/55, and in particular 35/65 to 40/60.

In the case of chocolate, inclusions may be produced during its preparation whose size will depend on the desired confectionery, or even a single inclusion, the said inclusions consisting of confectionery products according to the present invention. The said chocolate with a reduced cooling effect or with no cooling effect may contain quantities of xylitol much higher than the prior art, and in any case of at least 10% by weight of xylitol.

The invention therefore also relates to a sugar-free chocolate, characterized in that it comprises a confectionery product according to the present invention, in the form of one or more inclusions.

The said sugar-free chocolate will be preferably a maltitol, lactitol or isomalt chocolate.

According to another variant of the present invention, the confectionery products may comprise another polyol, such as in particular mannitol, so as to control the texture of the confectionery. Mannitol indeed crystallizes in preference to xylitol in the presence of anticrystallizing dextrins. It will also be possible to use, to this end, isomalt or any other polyol having at the same time a low solubility and a low cooling effect in the mouth. Such polyols are particularly effective for controlling the texture of soft confectionery products as described above.

According to an advantageous variant, the confectionery products according to the invention additionally comprise mannitol. Good results have been obtained for confectionery products comprising by weight on a dry basis 5 to 15% of mannitol, 18 to 24% of hydrogenated dextrins and 36 to 42% of xylitol.

To prepare the confectionery products according to the present invention, conventional processes may be used. In the case of chocolate, a confectionery product will be first of all prepared which comprises the mixture of xylitol and indigestible dextrins, which will then be either incorporated into a chocolate matrix after having been ground or cut up, or coated as they are with chocolate by a conventional covering process.

A subject of the invention is also an amorphous mixture of xylitol and indigestible dextrins in which the xylitol/ dextrin weight ratio is between 25/75 and 75/25, preferably between 70/30 and 30/70 or else between 65/35 and 35/65.

It goes without saying that the present invention applies to other polyols having a cooling effect, such as in particular erythritol. In this case, the best results were obtained with an erythritol/dextrin ratio of 40/60 in terms of texture and absence of cooling effect.

The invention will be understood more clearly on reading the examples which follow, which are intended to be illustrative and non-limiting.

### EXAMPLE 1

### Preparation of a Caramel According to the Invention

Caramels according to the invention are prepared which comprise a mixture of xylitol and indigestible dextrins.

Trial A: xylitol, Nutriose® FB6, ratio 40/60

Trials B and C: xylitol, Nutriose® FB6, mannitol in a 35/55/10 ratio

| | Trial A | Trial B | Trial C |
|---|---|---|---|
| Xylitol | 280 | 238 | 241.5 |
| Nutriose ®FB6 | 420 | 374 | 379.5 |
| Mannitol | | 68 | 69 |
| Salt | 2 | 2 | 2 |
| Vegetable fat (Loders Croklaan) | 60 | 60 | 60 |
| Glyceryl monostearate | 3 | 3 | 3 |
| Vanillin | 0.1 | 0.1 | 0.1 |
| Flavour (IFF) | 3.9 | 3.9 | 3.9 |
| Water | 231 | 231 | 231 |
| Gelatin 200 blooms (Rousselot) | | 20 | 10 |

Procedure: the dextrins are first dissolved in water, the polyols and the salt are then added.

The gelatin is dissolved in water at 60° C. for 1 hour.

The fat is melted.

The mixture of polyols and dextrins is boiled at 135° C., the other ingredients are then added, and then the mixture is cooled to 90° C., the gelatin is added, as well as the flavours.

The massecuite is then spread on marble, and then cut up or shaped.

The confectionery products thus prepared do not have a cooling effect. They may additionally be coated with chocolate.

### EXAMPLE 2

### Preparation of Confectionery Products According to the Invention—Variation of the Xylitol/Dextrin Ratios

Various xylitol/dextrin ratios are tested, between 30/70 and 70/30.

The dextrins used for this trial are hydrogenated pyrodextrins.

The quantities are expressed as percentage by weight.

1. Preparation of Boiled Sugars

| | Ratio | | | | | | | | |
|---|---|---|---|---|---|---|---|---|---|
| | 30/70 | 35/65 | 40/60 | 45/55 | 50/50 | 55/45 | 60/40 | 65/35 | 70/30 |
| Xylitol | 20.62 | 24.06 | 27.5 | 30.94 | 34.38 | 37.82 | 41.26 | 44.69 | 48.13 |
| Hydrogenated dextrin | 48.14 | 44.7 | 41.26 | 37.82 | 34.38 | 30.94 | 27.50 | 24.07 | 20.63 |
| Water | 30 | 30 | 30 | 30 | 30 | 30 | 30 | 30 | 30 |
| Intense sweetener | 0.04 | 0.04 | 0.04 | 0.04 | 0.04 | 0.04 | 0.04 | 0.04 | 0.04 |
| Citric acid | 0.6 | 0.6 | 0.6 | 0.6 | 0.6 | 0.6 | 0.6 | 0.6 | 0.60 |
| Lemon flavour | 0.6 | 0.6 | 0.6 | 0.6 | 0.6 | 0.6 | 0.6 | 0.6 | 0.60 |

The xylitol/dextrin mixture is dissolved in water and boiled at 180° C. During cooling, the intense sweetener is added, together with the flavour and the colouring.

The mass is then shaped by casting in moulds.

The confectionery products are released from the moulds after cooling.

The most conclusive trials are for the ratios between 30/70 and 45/55, and in particular 35/65 and 40/60.

The 50/50 ratio gives slightly softer boiled sugars.

From 55/45, the mould release becomes difficult, and above 70/30, the mass becomes very sticky.

Below 30/70, the casting is difficult and the mixture foams strongly. The boiling also becomes difficult.

The confectionery products obtained do not have a cooling effect.

2. Preparation of Soft Caramels

The quantities are expressed as percentage by weight.

| | Ratio | | | | | |
|---|---|---|---|---|---|---|
| | 60/40 | 65/35 | 70/30 | 60/40 | 65/35 | 65/35 |
| Xylitol | 36 | 39 | 42 | 36 | 42 | 42 |
| Hydrogenated | 24 | 21 | 18 | 24 | 18 | 18 |
| dextrin | | | | | | |
| Salt | 0.2 | 0.2 | 0.2 | 0.2 | 0.2 | 0.2 |
| POLYSORB ® | 10 | 10 | 10 | 15 | 15 | 20 |
| 75/08/55 | | | | | | |
| Water | 7.8 | 7.8 | 7.8 | 7.8 | 7.8 | 7.8 |
| Vegetable | 6 | 6 | 6 | 6 | 6 | 6 |
| fat | | | | | | |
| Gelatin | 0.6 | 0.6 | 0.6 | 0.6 | 0.6 | 0.6 |
| Vanillin | 0.02 | 0.02 | 0.02 | 0.02 | 0.02 | 0.02 |
| Caramel | 0.38 | 0.38 | 0.38 | 0.38 | 0.38 | 0.38 |
| flavour | | | | | | |
| Mannitol | 15 | 15 | 15 | 10 | 10 | 5 |

The best results are obtained with the 65/35 ratio. Above (70/30), a slight cooling effect is observed.

The 60/40 ratio gives a satisfactory chewy paste texture.

The confectionery products comprising the 65/35 ratio are then coated with chocolate; a chocolate confectionery product having a high xylitol content and no cooling effect is thereby obtained.

3. Preparation of Hard Gums

The quantities are expressed as percentage by weight.

| | Ratio | | |
|---|---|---|---|
| | 55/45 | 60/40 | 65/35 |
| Xylitol | 20.8 | 22.75 | 24.62 |
| Hydrogenated dextrin | 17.08 | 15.12 | 13.25 |
| Water | 11 | 11 | 11 |
| Gum arabic (50%) | 49.96 | 49.96 | 49.96 |
| Citric acid (50%) | 0.97 | 0.97 | 0.97 |
| Acesulfame K | 0.1 | 0.1 | 0.1 |
| Flavour | 0.1 | 0.1 | 0.1 |

The boiling of these mixtures is carried out at 128° C., after which they are cast in moulds and cooled.

According to the invention, it is possible to obtain, depending on the ratios tested, hard gums having a high xylitol content and no cooling effect.

4. Preparation of Bilayer Boiled Sugars

A boiled sugar is prepared comprising a layer having a high xylitol content and no cooling effect according to the invention and a crystallized xylitol layer alone so as to offer the consumer a confectionery product having a cooling surface and a neutral surface. The confectionery products are prepared according to the following formula:

Layer with no cooling effect (xylitol/dextrin ratio 40/60)

| | Composition by | Composition of the |
|---|---|---|
| | weight | finished product |
| Xylitol | 29.5 | 38.55% |
| Nutriose ® FB 06 | 44.25 | 57.82% |
| Water | 25 | 0.00% |
| Lactic acid | 0.75 | 0.98% |
| Acesulfame K | 0.05 | 0.07% |
| Lemon flavour QL 70945 | 0.35 | 0.46% |
| Milk flavour QL 17162 | 0.05 | 0.07% |
| Yellow colouring (10%) | 0.05 | 0.07% |
| Water content | — | 2.00% |
| Total: (kg) | 100 | 100.00% |

Crystallized layer with xylitol

| | Composition by | Composition of the |
|---|---|---|
| | weight | finished product |
| Xylitol | 99.95 | 99.73% |
| Mint flavour QL 63127 | 0.05 | 0.07% |
| Moisture | — | 0.20% |
| Total: (kg) | 100 | 100.00% |

Procedure:

Layer with No Cooling Effect (Transparent and Yellow)
The xylitol and the dextrin Nutriose® FB 06 are mixed in water, and the mixture is boiled at 120° C.
The flavour, the acid and the colouring are then added.
The mixture is cast in moulds, and then cooled.

Crystallized Layer (White)
85-90% xylitol is first melted at 95° C.
The remaining 10-15% xylitol are then added as primer to the molten xylitol syrup,
the carefully mixed syrup is then manually deposited on the preceding layer,
the confectionery products obtained are then cooled and then recovered.

Bilayer confectionery products are obtained, of which only one surface, in accordance with the invention, possesses a cooling effect and not the other.

### EXAMPLE 3

### Preparation of Confectionery Products According to the Invention Variation of the Erythritol/Dextrin Ratios

Various erythritol/dextrin (E/D) ratios are tested, between 30/70 and 70/30.

The indigestible dextrins used for this trial are branched maltodextrins.

The quantities are expressed as percentage by weight.

1. Preparation of Hard Caramels and Soft Caramels

Formulation

| | Hard | Hard | Soft | Soft | Soft |
|---|---|---|---|---|---|
| | E/D | E/D | E/D | E/D | E/D |
| | 40/60 | 50/50 | 40/60 | 45/55 | 50/50 |
| | by | by | by | by | by |
| Ingredients | weight | weight | weight | weight | weight |
| Erythritol | 25.44 | 31.80 | 20.64 | 23.20 | 25.80 |
| Dextrin | 38.16 | 31.80 | 30.96 | 28.38 | 25.80 |
| Mannitol | 4.00 | 4.00 | — | — | — |
| Polysorb ® | — | — | 14.00 | 14.00 | 14.00 |
| 75/08/55 | | | | | |
| Salt | 0.20 | 0.20 | 0.20 | 0.20 | 0.20 |
| Water | 21.20 | 21.20 | 17.20 | 17.20 | 17.20 |
| Vegetable | 6.00 | 6.00 | 6.00 | 6.00 | 6.00 |
| fat | | | | | |
| Lecithin | 0.60 | 0.60 | 0.60 | 0.60 | 0.60 |
| Mannitol | 4.00 | 4.00 | 10.00 | 10.00 | 10.00 |
| (primer) | | | | | |
| Vanillin | 0.02 | 0.02 | 0.02 | 0.02 | 0.02 |
| Caramel | 0.38 | 0.38 | 0.38 | 0.38 | 0.38 |
| flavour | | | | | |
| Total | 100.0 | 100.0 | 100.0 | 100.0 | 100.0 |

Boiling parameters

| | | | | | |
|---|---|---|---|---|---|
| Temperature | 170° C. | 170° C. | 118° C. | 118.0° C. | 120.0° C. |

The caramels are coated with sugar-free chocolate

The best results in terms of texture and absence of cooling effect are obtained with the E/D ratio=40/60 either for hard caramels or for soft caramels.

1. Sugar-free confectionery rich in xylitol, comprising an amorphous mixture of xylitol and indigestible dextrins.

2. Confectionery according to claim 1, comprising an amorphous mixture of xylitol and indigestible dextrins in a weight ratio of between 25/75 and 75/25.

3. Confectionery according to claim 1, wherein said confectionery is a boiled sugar, a hard caramel, a soft caramel, a toffee, a chewy paste or a chocolate.

4. Confectionery according to claim 1, comprising on a dry basis from 20 to 55% of xylitol and 15 to 75% of dextrins.

5. Confectionery according to claim 1, further comprising mannitol, maltitol, isomalt, inulin or gum arabic.

6. Confectionery according to claim 5, comprising by weight on a dry basis 36 to 42% of xylitol, 18 to 24% of dextrins and from 5 to 15% of mannitol.

7. Confectionery according to claim 1, wherein said dextrins are hydrogenated.

8. Confectionery according to claim 1, wherein said confectionery is incorporated into a dark, white or milk sugar-free chocolate.

9. Confectionery according to claim 8, wherein said chocolate is a maltitol chocolate.

10. Confectionery according to claim 1, wherein said confectionery is a chewy paste.

11. Sugar-free confectionery rich in erythritol, comprising an amorphous mixture of erythritol and indigestible dextrins.

12. Amorphous mixture of xylitol and indigestible dextrins in which the xylitol/dextrin weight ratio is between 25/75 and 75/25.

13. Amorphous mixture of erythritol and indigestible dextrins in which the erythritol/dextrin weight ratio is between 25/75 and 75/25.
